(19) United States
(12) Patent Application Publication
(10) Pub. No.: US 2008/0067868 A1
(43) Pub. Date: Mar. 20, 2008

(54) BPL Low-Voltage Coupler

(76) Inventors: Richard Kenneth Murphy, Sugar Land, TX (US); Donato Cortez, Sugar Land, TX (US); Richard L. Grasshoff, Richmond, TX (US)

Correspondence Address: BAKER BOTTS, LLP, 910 LOUISIANA, HOUSTON, TX, 77002-4995, US

(21) Appl. No.: 11/781,683

(22) Filed: Jul. 23, 2007

Related U.S. Application Data
(60) Provisional application No. 60/820,100, filed on Jul. 21, 2006.

(51) Int. Cl. H04B 3/54

(52) U.S. Cl. 307/3

(57) ABSTRACT

Method and system for transmitting data using power lines are disclosed. The method includes tying low voltage lines for the transmission of BPL signals but maintaining isolation of those voltage circuits in accordance with normal power distribution system practices. The system includes a plurality of power transformers, one or more low voltage circuits, wherein the low voltage circuits operate as separate electrical circuits, and a low voltage signal coupler, operable to couple one or more of the low voltage circuits.

### CROSS-REFERENCE TO RELATED APPLICATION

This application claims priority to commonly owned U.S. provisional patent application Ser. No. 60/820,100, filed Jul. 21, 2006, entitled “BPL Low-Voltage Coupler,” by Richard Kenneth Murphy, et al., which is hereby incorporated by reference.

### TECHNICAL FIELD

The present invention relates generally to data transmission networks and more particularly to the transmission of data over power lines.

### BACKGROUND

Broadband signals are commonly transmitted on power lines through the use of Broadband over Power Line (BPL) technology. This technology has been advancing and is being used by numerous entities in the United States and around the world to provide broadband internet access through the power line infrastructure. BPL signals normally require a continuous electric signal path, such as a circuit or line, in order to propagate from one point to another. Generally, in order to move a BPL signal from one electric line to another, different voltage, the signal has needed to be extracted from the source line, taken through a BPL repeater device, e.g., in order to by-pass a power transformer, and re-inserted on the destination electric line. The BPL signal may then propagate down a low voltage line tied to the transformer. BPL repeater devices, used to by-pass power transformers in order to preserve signal integrity, are expensive and many would be required to build a network of communications.

### BRIEF DESCRIPTION OF THE DRAWING

For a more complete understanding of the present invention and the advantages thereof, reference is now made to the following description taken in conjunction with the accompanying drawing in which like reference numbers indicate like features, and wherein:

FIG. 1 illustrates an example BPL low-voltage coupling system of the present disclosure.

### DETAILED DESCRIPTION

In general, as used herein, the term Broadband over Power Lines (BPL) includes any data transmission over power lines. In one embodiment of the present invention, a method and system involving an arrangement of low voltage circuits fed from multiple power transformers (1, 9, 10) is provided such that a BPL signal can propagate from one low voltage line (3, 6, 8) to another. The low voltage lines (3, 6, 8) are not directly electrically tied, so the low voltage circuits can operate as separate electrical power circuits, which can enhance the robustness of the system. The circuits are coupled for BPL signals through a low voltage signal coupler (5, 7). The coupler is a device which isolates itself from the lines it couples in the event of an internal failure of the coupler in order to prevent disruption to the low voltage power system. The coupler prevents signal and electrical power flow through it when there is loss of voltage to either of the low voltage lines it couples. The coupler prevents signal and electrical power flow through it when there is a low voltage line short on either low voltage line, as well. Internal to the coupler device, the coupler is connected to the low voltage lines it couples through ‘weak link’ connections in order to limit any potential short circuit currents. The housing of the coupler is a non-conductive material that will allow it to operate in an outdoor environment. Normally low voltage (such as 600 volts or less) circuits are configured to be a radial line fed from a transformer, which is either pole mounted or pad mounted. This embodiment of the present invention has the properties to allow the connection of several low voltage lines together for the transmission of a BPL signal, but remain separate for power flow.

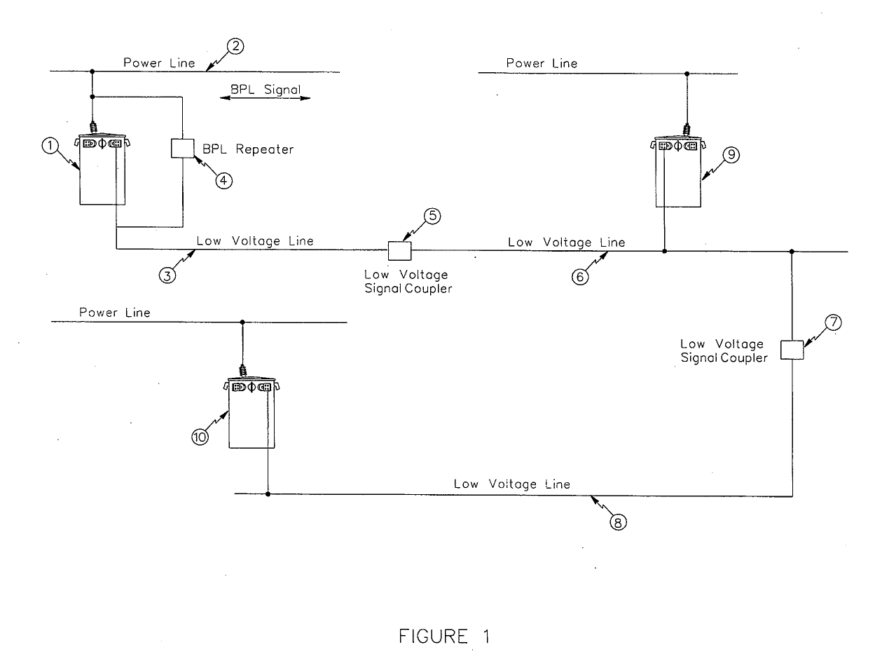

As shown in FIG. 1, this embodiment makes possible the transmission of BPL or other broadband signals without the need for signal repeaters at every power transformer and the safe and reliable operation of the low voltage grid. The present invention is adapted for use on power distribution circuits or any other low voltage (such as 600 volts or below) systems. Low voltage systems are ideal for BPL transmission and offer opportunities to utilize low voltage circuits for communications of voice, data and video. Since low voltage circuits exist commonly in most homes and businesses, possible communications applications include data transmission, internet access, communications within homes and businesses, as well as monitoring and control of appliances and equipment with intelligent electronic devices. The broadband signals on low voltage electric lines can reach into the hundreds of megabits per second. Utilization of the invention according to this embodiment will enable the spread of broadband connectivity over the power grid to homes and businesses, without any significant new installations of communication facilities. The BPL signals will travel along the exiting power lines, and the consumer will be able to use the communication capabilities.

The BPL signals imposed on power line 2 (FIG. 1) are transmitted to low voltage line 3 through BPL repeater 4, by-passing power transformer 1. The signal propagates along the line 3 until it reaches the low voltage signal coupler 5. The BPL signal is passed through the coupler and is imposed on the low voltage line 6. The signal propagates down line 6 to another coupler 7, and then propagates down low voltage line 8. The signal may be sent over several low voltage circuits, thereby avoiding the need for separate repeater devices to allow the BPL signal to bypass individual power transformers 9 and 10.

The present invention is therefore well-adapted to carry out the objects and attain the ends mentioned, as well as those that are inherent therein. While the invention has been depicted, described and is defined by references to examples of the invention, such a reference does not imply a limitation on the invention, and no such limitation is to be inferred. The invention is capable of considerable modification, alteration and equivalents in form and function, as will occur to those ordinarily skilled in the art having the benefit of this disclosure. The depicted and described examples are not exhaustive of the invention. Consequently, the invention is intended to be limited only by the spirit and scope of the appended claims, giving full cognizance to equivalents in all respects.

1. A method for transmitting data using an electrical power distribution system comprising:
coupling low voltage circuits for the transmission of BPL signals while maintaining the separation of those circuits for power transmission purposes.

2. A system for transmitting data signals using an electrical power distribution system comprising:
a plurality of power transformers;
one or more low voltage circuits fed from one or more of the plurality of power transformers, wherein the low voltage circuits operate as separate electrical circuits, and wherein at least one of the low voltage circuits comprises a low voltage power line; and
a low voltage signal coupler.

3. The system of claim 2, further comprising a repeater to pass the signals across a power transformer.

4. The system of claim 2, wherein the coupler is operable to isolate itself from a low voltage circuit in the event of a coupler failure.

5. The system of claim 2, wherein the coupler prevents signal and electrical power flow across the coupler in the event of a loss of voltage to one or more of the low voltage circuits.

6. The system of claim 2, wherein the coupler prevents signal and electrical power flow across the coupler in the event of an electrical short circuit in one or more of the low voltage circuits.

7. The system of claim 2, wherein the coupler is coupled to one or more of the low voltage circuits through connections that limit short circuit currents through the coupler in the event of a coupler failure.

8. The system of claim 2, wherein the coupler has a housing of a non-conductive material.
